(19) United States
(12) Patent Application Publication
(10) Pub. No.: US 2004/0264333 A1
(43) Pub. Date: Dec. 30, 2004

(54) [METHOD OF READING DATA FROM HIGH DENSITY OPTICAL RECORDING MEDIUM]

(76) Inventors: Hsun-Hao Chang, Taipei County (TW); Bing-Mau Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,268

(22) Filed: Jun. 30, 2004

(30) Foreign Application Priority Data
Jun. 30, 2003 (TW) 92117780

(51) Int. Cl. G11B 7/00; G11B 5/09

(52) U.S. Cl. 369/59.2; 369/275.2

(57) ABSTRACT

A method for reading data from high density optical recording media is disclosed. In this method, a value is generated from a formula Pr/(λ/NA), wherein Pr is light source reading power; λ is wavelength; and NA is numerical aperture, when the value is in a range of about 1.15 to about 8 mW/μm, a recording mark within the high density optical recording medium which is smaller than a resolution limit of an optical system is detected.

### CROSS REFERENCE TO RELATED APPLICATIONS

This application claims the priority benefit of Taiwan application serial no. 92117780, filed on Jun. 30, 2003.

### BACKGROUND OF INVENTION

1. Field of the Invention

The present invention relates to a method of reading data from an optical recording medium, and more particularly to a method of reading data from a high density optical recording medium.

2. Description of Related Art

Because new electronic devices, such as computer, communication and consumer electronic products, are being popularly used, the demand for extending storage capacities of these electronic devices continues to increase. For example, CD, CD-R and CD-RW, which have low prices, high read/write speed and high compatibility with other devices are generally used in recording media. For reading data from an optical disk, a laser beam is focused onto the active surface of the optical disk, which transmits through a transparent substrate and the reflected light upon impinging on pits formed on the optical disk is picked up by the pick up head.

Because of the high demand for high storage density, small size and low manufacturing cost for storage media, high density optical recording media has become the main stream of development. To increase the density of the storage media, generally, one approach is to efficiently compile the data, another approach is to reduce the pit size and the track pitch, yet another approach is to increase the NA of pick up head, and still yet another approach is to utilize short-wavelength laser and multiple-layer technology.

Digital Versatile Disc (DVD) uses optical lens with high NA and short-wavelength laser for increasing storage capacity. It has eight times the storage capacities of a general optical disk, which is achieved by reducing track pitches of the disc and the sizes of light spots of the pick up heads. Therefore, the track pitches of DVD are being shrunk from 1.6 μm to 0.74 μm, and the sizes of light spots are being shrunk form 1 μm to 0.65 μm.

The shrinkage of light spots comes from the utilization of short-wavelength laser and increase of NA of object lens. Recently, Blue-Ray-System-Disc has a capacity from 23.3 to 27 GB, which is five times that of DVD. It can record a two-hour program of high definition TV (HDTV) or a thirteen-hour program of normal TV. Blue-Ray-System-Disc has a superior capacity because of shrinkage of light spots and increase of NA of lens. Presently, the smallest recording mark length fabricated is about 140 nm.

From the above descriptions, the development of recording density of optical disc focuses on shrinkage of light spots. When the light spots shrink, however, the wave-length of laser will reduce and NA of lens will increase. The increase of NA of lens is implemented by reducing focal length of the object lenses and by positioning the pick up head close to the disc. However, when the pick up head is too close to the optical disk, the pick up head may touch the optical disk and gets damaged. Moreover, shrinkage of light spots and the increase of NA of lens are limited due to limitation of wave-length of the laser. The equipment used for fabricating DVD is not suitable to manufacture Blue-Ray-System-Disc; therefore additional equipments are required and thereby increasing the manufacturing cost.

In a situation when the mark size is smaller than the radius of a focused light spot, it is difficult for optical systems to determine the two such neighboring marks due to diffraction phenomenon. According to Rayleigh principle, the observation of an object in a distance larger than the wavelength of light will be affected by diffraction limit. In other words, the resolution limit of a traditional optical microscope is λ/2 of focus light. Under Rayleigh principle, the distance between two objects must be larger than, or equal to, 1.22λ/2 nsin θ then these two objects can be observed as distinct objects, wherein λ is light wavelength, n is refractive index, θ is half angle of an object aperture. The formula used to measure the size of light spot is: λ/2NA, which is similar to the formula of diffraction limit. For the DVD system, the light spot size is 531 nm when λ is 637.7 nm and NA is 0.6.

Presently, the smallest size recording mark of a DVD fabricated is about 400 nm, which is smaller than the focused light spot. Because of diffraction limit, theoretically, the data stored therein cannot be read. However, because a non-recording area of about 400 nm is formed between two recording marks, the pick up head reads the recording mark train and generates different periodic square waveforms. Therefore, “0” and “1” digital signals are generated therefrom. The distance between centers of neighboring recording marks is 800 nm, which is larger than the focused laser light spot and the issue of diffraction does not occur. The formula suitable for optical disk in measuring diffraction limit is λ/4NA, which is half of the focused light spot and called as resolution limit. The resolution limit of DVD is 265 nm. It means that when the recording mark is smaller than the resolution limit, the carrier to noise ratio (CNR) value is small and cannot be read by the pick up head.

In order to overcome this problem, a super-resolution near field structure is proposed. The application of super-resolution near field is capable of increasing the capacity of optical disc by 2 to 20 times.

Near Field Optics is a new theory. In 1928, E. H. Synge had proposed to get optical signals within a near field range, i.e. before the generation of electromagnetic wave interference and diffraction in order to overcome the limitation due to diffraction. In 1956, an American, O”keefe, also proposed the same theory in which a hole smaller than the wavelength of light is used to detect optical signals. Because the limitation of technology, the theory could not be proved. In 1972, E. A. Ash and G. Nicholes used microwave having 3-cm wavelength to prove the theory. They got a resolution about 1/60 wavelength near to an object before the generation of diffraction. It was the first time that the near field theory was proved.

In 1992, Bell Lab. of AT&T found super high density surface record on a CoPt multiple layer by near field optical theory. They used a nano-degree fiber probe for transmitting and receiving light, formed 60-nm recording marks on the CoPt multiple thin layer and collected signals from the recording marks. From their experimental results, each square inch could store 45 Giga bits data. But, the disadvantages of the method are that the nano-degree fiber probe is fragile, that a high precision control equipment is required to maintain the probe in a required distance and read/write and record speeds are very slow. Therefore, it is not suitable for the modern recording media with high read/write speed, high mobility and robustness thereof.

In 1998, Dr. Junji Tominaga in Agency of Industrial Science and Technology of MITI in Japan disclosed super-resolution optical near-field structure (Super-RENS) for recording near field optical signals. His idea is very easy and totally changed the development of near field recording. He used a nano-degree non-lineal optical thin film and a dielectric layer to replace the fiber probe, nano-degree optical hole and a feed-back apparatus for maintaining the probe close to the sample. Because, the material property of the non-lineal optical film, such as Sb, AgOx, or WOx, and the fixed space between the non-lineal optical film and the dielectric layer, the super-resolution optical near-field recording is achieved by using laser to control the recording mark sizes, which are smaller than the diffraction limit, wherein the film structure included a substrate, a bottom dielectric layer, a non-lineal optical layer, an isolation layer, a recording layer and a top dielectric layer. Therefore, the problems generated from the fiber probes and disk closed driver are eliminated. The theory is that a laser light passes through the substrate and the bottom dielectric layer, and makes oxide thin film generate metal grains thereon, forming a scattering spot. Because of the near field distance, diffraction limit is avoided and light from the scattering spot will be absorbed and reflected in the recording layer for identifying mark sizes.

Therefore, near-field optical disk has 2 to 20 times the capacity of traditional optical disk just by changing the track pitch of optical disk, mark sizes and film structures of optical disk without changing hardware of disk drivers.

Although near-field optical disk has 2 to 20 times the capacity of traditional optical disk, it still needs additional non-lineal optical thin film layer and dielectric layer.

The present invention discloses a method different from the super-resolution non-lineal optical method that is simple but different from the traditional methods applied to commercial recording media, such as CD, DVD, etc. It can be applied to recording media without non-lineal optical layers.

Traditionally, the reading power used in disk driver is lower than 1 mW, which is about 0.7 mW, and the smallest mark is larger than the resolution limit. No disk driver having reading power more than 1 mW has been applied thereto. Traditional recording media, such as CD-R, CD-RW, DVD-R, DVD-RW and DVD-RAM, do not have the non-lineal optical layers. Therefore, no super-resolution phenomenon has been reported in this system.

Moreover, it is generally believed that non-lineal optical layers in the recording medium of the optical disk are prerequisite requirement for providing super-resolution phenomenon to generate surface plasma. Nobody has ever thought of the other possibilities.

The present invention discloses a method, which is different form the traditional and super-resolution optical methods to achieve super resolution by using recording media without the non-lineal optical layer.

The material generated from the non-lineal optical layer is metal having non-lineal optical characteristics. In addition, the phase-change recording layer also comprises a metal. If a single metal layer posses the non-lineal optical characteristics, the process can be simplified. Further, because the single metal layer posses the non-lineal optical characteristics, and therefore, it is possible to record and read recording marks smaller than the resolution limit.

In general, when the resolution limit is high, the CNR value of conventional optical recording medium does not increase significantly as the reading power increases and reaches a constant value. Alternatively, if the reading power is too high, the CNR value is reduced due to high energy, which would easily damage some of the recording point.

### SUMMARY OF INVENTION

Therefore, the object of the present invention is to provide a method for reading data from a high density optical recording medium. Even though the length of the recording mark is smaller than the resolution limit of an optical system, the optical signal therefrom can be detected. Therefore, the issue of resolution limit is resolved and the recording density of the medium is increased.

Another object of the present invention is to reduce costs of the manufacturing. The recording mark smaller than the resolution limit of an optical system can be detected by using a recording medium without requiring the non-lineal optical layers and thereby raising light source reading power thereon. Accordingly, costs on fabrication cost of non-lineal optical layers can will not be avoided increased as the existing production line can be utilized and does not require any special apparatus and thus the overall manufacturing cost can be effectively reduced.

A further object of the present invention is to burn the optical recording medium in a manner that the result of the burning of the recording medium meets the present spec.

In accordance with the objects described above, the present invention provides a method for reading data from a high density optical recording medium. A high density optical recording medium comprises: a substrate; a first dielectric layer formed on the substrate; a recording layer formed on the first dielectric layer, the recording layer for absorbing heat and generating a recording mark with a different reflective index after being exposed to a laser light source; a second dielectric layer formed on the recording layer; a reflective layer formed on the second dielectric layer and a polymer layer formed on the reflective layer. When reading data, light passes through a splitter and a lens and travels to recording marks within the high density optical recording medium, lights reflected from the recording marks with different reflective indexes pass through the splitter to an optical detector where the reflected lights are transformed into electrical signals. The electrical signals are processed by a decoder for generating readable signals. Then a value is generated from a formula Pr/(λ/NA), which is an empirical formula, wherein Pr is a light source reading power (mW); λ is a wavelength (μm); and NA is a numerical aperture, when the value is from about 1.15 to about 8 mW/μm, a recording mark within the high density optical recording medium which is smaller than a resolution limit of an optical system is detected. When Pr1 is larger than Pr2 and Pr1/(λ/NA)>1.15, CNR of Pr1 is larger than that of Pr₂ by testing the recording marks smaller than the resolution limit of an optical system. Therefore, the recording signal of Pr₁ is better than that of Pr₂.

The recording layer is a combination of an element selected from a group consisting of Ge, Sb, Te, Ag, In, Sn, Se, Ga, Bi and V group element, and oxide or nitride thereof. The first dielectric layer and the second dielectric layer separately are SiNx, ZnS—SiO₂, AlNx, SiC, GeNx, TiNx, TaOx, YOx, GeCrN, AlNx, or a combination thereof. The reflective layer is selected from a group consisting of Au, Ag, Al, Ti, Pb, Cr, Mo, W, Ta, Cu, Pd and an alloy thereof.

The present invention discloses a method of reading data from a high density optical recording medium. The method of reading data capable of reading recording mark smaller than the resolution limit of an optical system and therefore the recording density can be further increased. Further, the recording mark smaller than the resolution limit of an optical system can be detected without requiring the non-lineal optical layers and thereby increasing the light source reading power thereon. Further, costs on fabrication of non-lineal optical layers can be avoided and thus the overall manufacturing cost can be effectively reduced.

In order to make the aforementioned and other objects, features and advantages of the present invention understandable, a preferred embodiment accompanied with figures is described in detail below.

### BRIEF DESCRIPTION OF DRAWINGS

FIG. 1 is a schematic drawing showing a method of reading data from a high density optical recording medium of the present invention.

FIGS. 2A-2D are cross-sectional configurations showing various high density optical recording media applied in the method of the present invention.

FIG. 3 is a first schematic configuration showing the relationship between the size of the recording mark and CNR when the light source reading power is 1.4 mW according to the method of the present invention.

FIG. 4 is a schematic EQ signal configuration showing the tested result under continuous reading mode after Equalier when the light source reading power is 2.4 mW according to the method of the present invention.

FIG. 5 is a schematic configuration showing the relationship between the size of the recording mark and CNR of a second tested result according to the method of the present invention.

FIG. 6 is a schematic EQ signal configuration showing a third tested result under continuous reading mode after Equalier when the light source reading power is 2.5 mW according to the method of the present invention.

### DETAILED DESCRIPTION

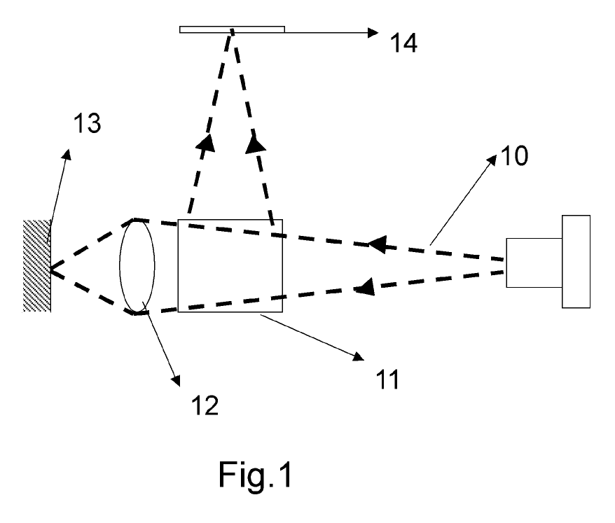

Referring to FIG. 1, a schematic drawing showing a method of reading data from a high density optical recording medium of the present invention is depicted.

Light from a light source 10 passes through a splitter 11 and a lens 12 and travels to recording marks (not shown) within the high density optical recording medium 13. Reflected lights upon impingement from the recording marks with different reflective indices pass through the splitter 11 and refract to an optical detector 14 where the reflected lights are transformed into electrical signals. The electrical signals are processed by a decoder (not shown) for generating readable signals.

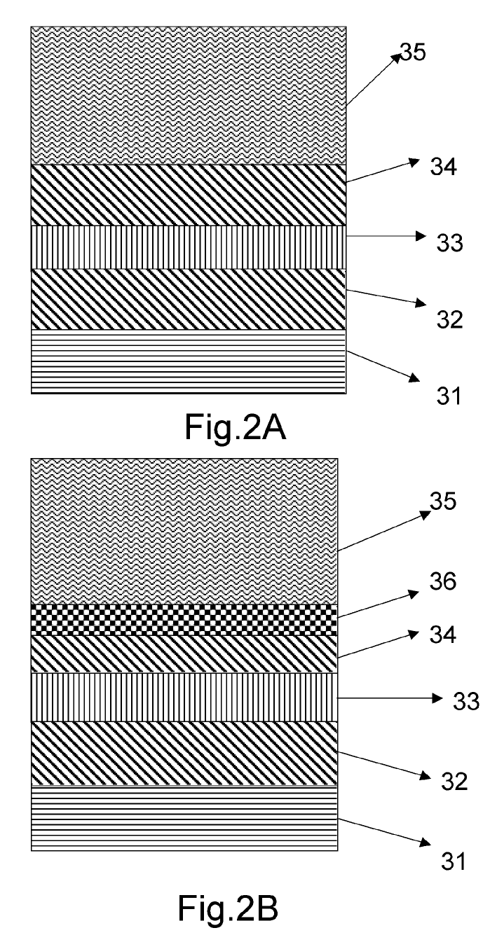

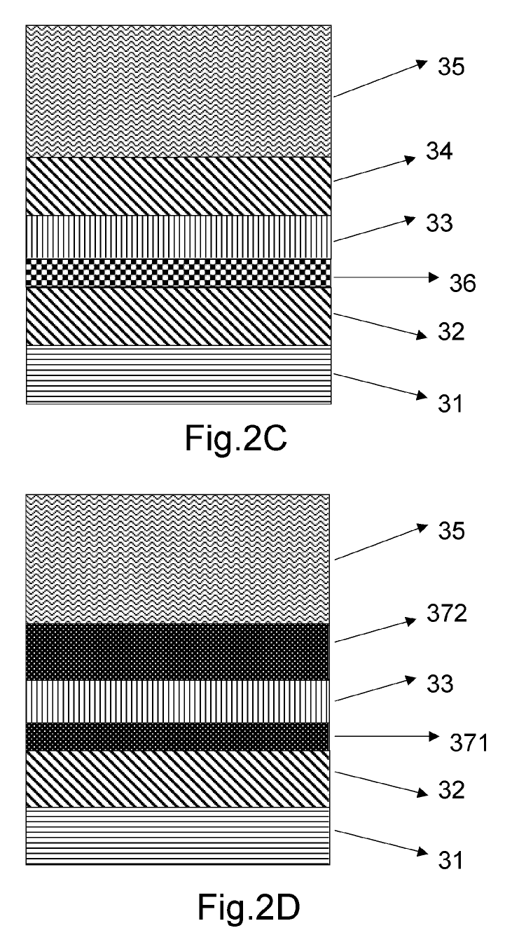

FIGS. 2A-2D are cross-sectional configurations showing various high density optical recording media applied in the method of the present invention. The high density optical recording media comprises: a substrate 31; a first dielectric layer 32 formed thereon; a recording layer 33 formed on the first dielectric layer 32, wherein the recording layer 33 is for absorbing heat and generating a recording mark with a different reflective index after being exposed to a laser light source; a second dielectric layer 34 formed on the recording layer 33; a reflective layer 35 formed on the second dielectric layer 34; and a polymer layer (not shown) formed on the reflective layer 35.

The substrate 31 is a transparent substrate having a signal surface, which is comprised of, for example, glass, Polycarbonate (PC), Polymethylmethacrylate (PMMA) or Metallocene Catalyzed Cyclo Olefin Copolymer (MCOC).

The first dielectric layer 32 is formed on the substrate 31, which is comprised of, for example, SiNx, ZnS—SiO₂, AlNx, SiC, GeNx, TiNx, TaOx, YOx, GeCrN or AlNx. The first dielectric layer 32 can be a single-layer dielectric or a multi-layer dielectric structure, wherein when the first dielectric layer is a multi-layer dielectric structure, the multi-layer dielectric structure can be fabricated using one or more dielectric layers comprising, for example, SiNx, ZnS—SiO₂, AlNx, SiC, GeNx, TiNx, TaOx, YOx, GeCrN or AlNx.

The recording layer 33 is formed on the first dielectric layer 32, which is comprised of, for example, a combination of an element selected from a group consisting of Ge, Sb, Te, Ag, In, Sn, Se, Ga, Bi and V group element, and oxide or nitride thereof. The second dielectric layer 34 is formed on the substrate 33, which is, for example, SiNx, ZnS—SiO₂, AlNx, SiC, GeNx, TiNx, TaOx, YOx, GeCrN or AlNx. The second dielectric layer 34 can be a single-layer dielectric or a multiple-layer dielectric, wherein when the second dielectric layer is a multi-layer dielectric structure, the multi-layer dielectric structure can be fabricated using one or more dielectric layers comprising, for example, SiNx, ZnS—SiO₂, AlNx, SiC, GeNx, TiNx, TaOx, YOx, GeCrN or AlNx.

The reflective layer 35 is selected from a group consisting of Au, Ag, Al, Ti, Pb, Cr, Mo, W, Ta, Cu, Pd and an alloy thereof. A polymer layer (not shown) is formed on the reflective layer.

Then a value is generated from a formula Pr/(λ/NA), wherein Pr is a light source reading power (mW); λ is a wavelength (μm); and NA is a numerical aperture, when the value is from about 1.15 to about 8 mW/μm, a recording mark within the high density optical recording medium which is smaller than a resolution limit of an optical system is detected.

Referring to FIG. 2B, the high density optical recording medium applied further comprises an isolation layer 36 between the second dielectric layer 34 and the reflective layer 35. As shown in FIG. 2C, an isolation layer 36 also can be formed between the first dielectric layer 32 and the recording layer 33. The isolation layer comprises, for example, SiC, SiO₂, TiO₂, Al₂Ox, GeCrN, GeN or AlNx.

Referring to FIG. 2D, the high density optical recording medium applied further comprises a first crystallization-acceleration layer 371 between the recording layer 33 and the first dielectric layer 32, and a second crystallization-acceleration layer 372 between the recording layer 33 and the reflective layer 35. The first and second crystallization-acceleration layers comprises, for example, SiC, GeCrN, GeN or AlNx.

In order to prove performance of the method for reading data from a high density optical recording medium of the present invention, following is a embodiment complied with configurations showing the method of reading data from a high density optical recording medium in accordance with the present invention.

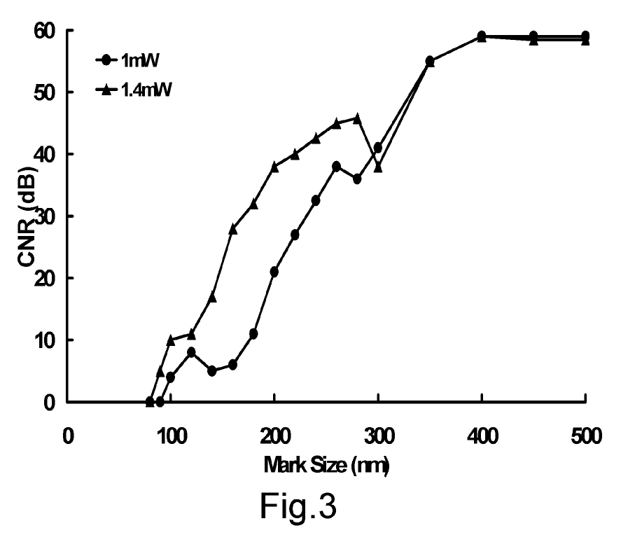

Referring to FIG. 3, a first schematic configuration showing the relationship between the size of the recording mark and CNR when the light source reading power is 1.4 mW according to the method of the present invention, wherein the structure of the optical recording medium is: PC/ZnS—SiO₂/AgInSbTe/ZnS—SiO₂/SiC/Ag. As shown in FIG. 3, when the size of the recording mark is 200 nm and reading power is 1.4 mW, CNR is 38 dB. The reading power 1.4 mW can trigger high-resolution mechanism and the recording marks with 350 nm have smaller thermal effects. Moreover, CNR curves of Pr=1 and 1.4 mW over-lap with each other; it means that the reading powers Pr=1 and 1.4 mW do not seriously affect the recording layer and erase the recording marks. When reading power is 1.4 mW and the recording mark is 200 nm, Pr/(λ/NA) is 1.317 and CNR is 38 dB. When reading power is 1 mW and the recording mark is 200 nm, Pr/(λ/NA) is 0.941 and CNR is 21 dB. They satisfy the requirements described above (λ=637.7 nm; NA=0.6).

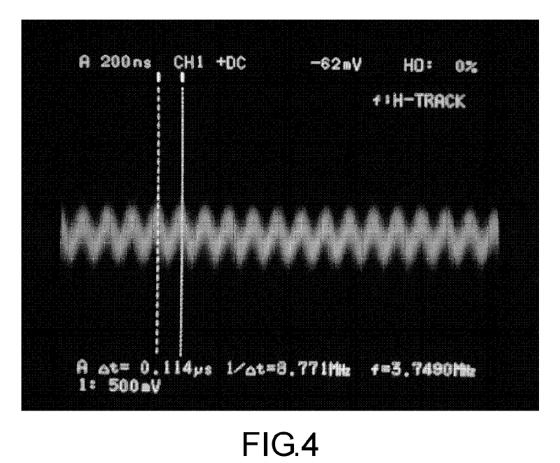

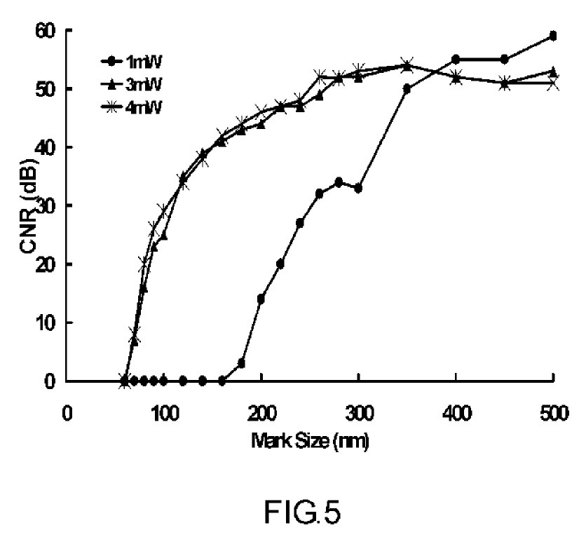

Referring to FIG. 4, numbers of 200-nm recording marks are recorded on a 5 mm band. Then a continuous reading mode is performed to avoid erasing prior tested recording marks. The continuous reading model means that the pick up head will go to different tracks, and do not repeat on the same track, which also is a normal operational mode within disk driver. Under the continuous reading mode, CNR is 42 dB when the size of the recording mark is 200 nm and reading power is 2.2 mW.

Referring to FIG. 5, a schematic configuration showing a second tested result according to the method of the present invention, wherein the structure of the optical recording medium is: PC/ZnS—SiO₂GeCrN/GeSbTe/GeCrN/AgCr is depicted. Under the continuous reading mode, GeSbTe can get a better CNR in which CNR is 46 dB when the size of the recording mark is 200 nm and reading power is 4 mW.

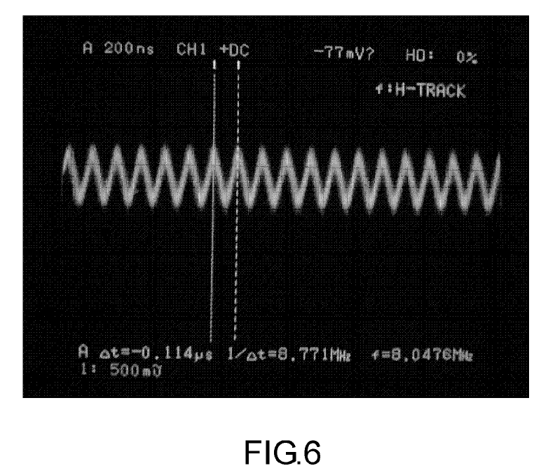

Referring to FIG. 6, a schematic EQ signal configuration showing the tested result under continuous reading mode after Equalier according to the method of the present invention, wherein the structure of the optical recording medium is: PC/ZnS—SiO₂/GeCrN/Ge₂Sb₂Te₅/GeCrN/AlCr is depicted. Under the continuous reading mode, CNR is 46 dB when the size of the recording mark is 200 nm and reading power is 2.5 mW.

From the descriptions above, under red-light system when Pr/(X/NA) is from about 1.15 to about 8 mW/μm, a recording mark within the high density optical recording medium which is smaller than a resolution limit of an optical system is detected, thereby allowing further increase in the recording density and also increase light source reading power without changing the structure of the optical recording medium.

Although the present invention has been described in terms of exemplary embodiments, it is not limited thereto. Rather, the appended claims should be constructed broadly to include other variants and embodiments of the invention, which may be made by those skilled in the field of this art without departing from the scope and range of equivalents of the invention.

1. A method for reading data from a high density optical recording medium; wherein the high density optical recording medium comprises:
a substrate;
a first dielectric layer formed on the substrate;
a recording layer formed on the first dielectric layer;
a second dielectric layer formed on the recording layer;
a reflective layer formed on the second dielectric layer;
the method comprising
generating a value using a formula Pr/(λ/NA), wherein Pr is a reading power, λ is a wavelength; and NA is a numerical aperture, wherein when the value is in a range of about 1.15 to about 8 mW/μm, a recording mark within the high density optical recording medium which is smaller than a resolution limit of an optical system is detected.

2. The method for reading data from a high density optical recording medium of claim 1, wherein the recording layer is a phase-change material.

3. The method for reading data from a high density optical recording medium of claim 2, wherein the phase-change material comprises a metal.

4. The method for reading data from a high density optical recording medium of claim 3, wherein the recording layer is a combination of an element selected from a group consisting of Ge, Sb, Te, Ag, In, Sn, Se, Ga, Bi and V group element, and oxide or nitride thereof.

5. The method for reading data from a high density optical recording medium of claim 1, wherein the first dielectric layer and the second dielectric layer separately comprises SiNx, ZnS—SiO₂, AlNx, SiC, GeNx, TiNx, TaOx, YOx, GeCrN, AlNx, or a combination thereof.

6. The method for reading data from a high density optical recording medium of claim 1, wherein a material of the reflective layer is selected from a group consisting of Au, Ag, Al, Ti, Pb, Cr, Mo, W, Ta, Cu, Pd and an alloy thereof.

7. The method for reading data from a high density optical recording medium of claim 1, wherein the high density optical recording medium comprises an isolation layer between the second dielectric layer and the reflective layer.

8. The method for reading data from a high density optical recording medium of claim 7, wherein the isolation layer is selected from a group consisting of SiC, SiO₂, TiO₂, Al ₂Ox, GeCrN, GeNx and AlNx.

9. The method for reading data from a high density optical recording medium of claim 1, wherein the high density optical recording medium comprises an isolation layer between the first dielectric layer and the recording layer.

10. The method for reading data from a high density optical recording medium of claim 9, wherein the isolation layer is selected from a group consisting of SiC, SiO₂, TiO₂, Al₂Ox, GeCrN, GeNx and AlNx.

11. The method for reading data from a high density optical recording medium of claim 1, wherein the high density optical recording medium comprises a first crystallization-acceleration layer between the first dielectric layer and the recording layer.

12. The method for reading data from a high density optical recording medium of claim 11, wherein the first crystallization-acceleration layer is selected from a group consisting of SiC, GeCrN, GeNx and AlNx.

13. The method for reading data from a high density optical recording medium of claim 11, wherein the high density optical recording medium comprises a second crystallization-acceleration layer between the recording layer and the reflective layer.

14. The method for reading data from a high density optical recording medium of claim 13, wherein the second crystallization-acceleration layer is selected from a group consisting of SiC, GeCrN, GeNx and AlNx.

15. The method for reading data from a high density optical recording medium of claim 1, wherein the high density optical recording medium comprises a polymer layer formed on the reflective layer.
